(19) United States
(12) Patent Application Publication
(10) Pub. No.: US 2008/0278004 A1
(43) Pub. Date: Nov. 13, 2008

(54) ELECTRONIC APPARATUS, POWER SUPPLY SYSTEM, AND METHOD FOR SUPPLYING ELECTRIC POWER

(75) Inventor: Junzo TOKUNAKA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SONY CORPORATION, Tokyo (JP)

(21) Appl. No.: 12/103,424

(22) Filed: Apr. 15, 2008

(30) Foreign Application Priority Data
May 9, 2007 (JP) 2007-124888

(51) Int. Cl. H02J 9/04

(52) U.S. Cl. 307/66

(57) ABSTRACT

An electronic apparatus includes a first terminal, a second terminal, elements, and a supply unit. The supply unit supplies electric power supplied from the first terminal and electric power supplied from the second terminal to the elements when the first and second terminals are connected to the first and second batteries, respectively. The electric power input to the second terminal is supplied to the elements after the first battery is detached from the mounting portion and the second terminal is connected to the second battery through the cable. The electric power input to the first terminal and the electric power input to the second terminal are supplied to the elements after the first and second terminals are connected to the second battery. The electric power input to the first terminal is supplied to the elements after the cable connected to the second battery is detached from the second terminal.

### CROSS REFERENCES TO RELATED APPLICATIONS

The present invention contains subject matter related to Japanese Patent Application JP 2007-124888 filed in the Japanese Patent Office on May 9, 2007, the entire contents of which are incorporated herein by reference.

### BACKGROUND OF THE INVENTION

1. Field of the Invention

The present invention relates to electronic apparatuses such as small video cameras, power supply systems which are used to supply electric power to the electronic apparatuses, and methods for supplying electric power.

2. Description of the Related Art

In general, many small electronic apparatuses that are used for a long period of time have electric power supplied from a commercial power supply or batteries. For example, when video cameras are used to film people or scenes in places where a commercial power supply is not available, only batteries are used as power supply sources. Accordingly, when the video cameras are used for a long period of time, a number of spare batteries should be provided for replacement.

Furthermore, when video cameras for business use are used for a long period of time, the video cameras are generally connected to a commercial power supply. However, the video cameras for business use should be provided with batteries as backup power supplies in the case of a blackout, for example (refer to Japanese Unexamined Patent Application Publication No. 10-285829).

### SUMMARY OF THE INVENTION

In a case where video cameras are used in places where a commercial power supply is not available, a plurality of spare video cameras are prepared for replacement. Accordingly, a shooting operation is not interrupted due to exchange of batteries since one of the plurality of spare video cameras is used to continue the shooting operation. However, when the shooting operation is performed in the wilderness such as a mountainous area, since the shooting operation should be performed with minimum equipment, only one video camera may be provided. In this case, since the shooting operation is interrupted when the batteries are exchanged, shooting of important scenes may fail.

In addition, small video cameras used for business purposes, for example, used for program productions, have a large number of components. Therefore, it is difficult to incorporate an extra battery for replacement in such a small video camera.

Accordingly, it is desirable to provide a small electronic apparatus usable for a long period of time even in places where a commercial power supply is not available, a power supply system, and a method for supplying electric power.

According to an embodiment of the present invention, there is provided an electronic apparatus including a first terminal which is disposed on a mounting portion in which a first battery or a second battery is to be mounted, and which is to be electrically connected to one of the first and second batteries, a second terminal which is to be electrically connected to the second battery through a cable and which is located in a position which does not disturb replacement of the first battery connected to the first terminal, elements which consume electric power, and a supply unit configured to supply at least one of electric power supplied from the first terminal and electric power supplied from the second terminal to the elements. The supply unit supplies the electric power supplied from the first terminal and the electric power supplied from the second terminal to the elements when the first terminal is connected to the first battery and the second terminal is connected to the second battery through a cable. The electric power input to the second terminal is supplied to the elements after the first battery is detached from the mounting portion and the second terminal is connected to the second battery through the cable. The electric power input to the first terminal and the electric power input to the second terminal are supplied to the elements after the first terminal is connected to the second battery and the second terminal is connected to the second battery through the cable. The electric power input to the first terminal is supplied to the elements after the cable connected to the second battery is detached from the second terminal.

According to another embodiment of the present invention, there is provided a power supply system including a first battery having a first power output terminal and a second power output terminal and a second battery having a first power output terminal and a second power output terminal, a first terminal which is disposed on a mounting portion in which a first battery or a second battery is to be mounted, and which is to be electrically connected to one of the first power output terminal of the first battery and the first power output terminal of the second battery, a second terminal which is to be electrically connected to the second power output terminal of the second battery through a cable and which is located in a position which does not disturb replacement of the first battery connected to the first terminal, elements which consume electric power, and a supply unit configured to supply at least one of electric power supplied from the first terminal and electric power supplied from the second terminal to the elements. The electric power input to the first terminal and the electric power input to the second terminal are supplied to the elements after the first terminal is connected to the first power output terminal of the first battery and the second terminal is connected to the second power output terminal of the second battery through the cable. The electric power input to the second terminal is supplied to the elements after the first battery is detached from the mounting portion and the second terminal is connected to the second power output terminal of the second battery through the cable. The electric power input to the first terminal and the electric power input to the second terminal are supplied to the elements after the first terminal is connected to the first power output terminal of the second battery and the second terminal is connected to the second power output terminal of the second battery through the cable.

According to a further embodiment of the present invention, there is provided a method for supplying electric power to a power supply system including a first battery having a first power output terminal and a second power output terminal and a second battery having a first battery having a first power output terminal and a second power output terminal and a second battery having a first power output terminal and a second power output terminal, a first terminal which is disposed on a mounting portion in which a first battery or a second battery is to be mounted, and which is to be electrically connected to one of the first power output terminal of the first battery and the first power output terminal of the second battery, a second terminal which is to be electrically connected to the second power output terminal of the second battery through a cable and which is located in a position which does not disturb replacement of the first battery connected to the first terminal, elements which consume electric power, and a supply unit configured to supply at least one of electric power supplied from the first terminal and electric power supplied from the second terminal to the elements. The method includes the steps of supplying the electric power supplied from the first battery and the electric power supplied from the second battery to the first terminal and the second terminal, respectively, to the elements, the first terminal being connected to the first power output terminal of the first battery, the second terminal being connected to the second power output terminal of the second battery through the cable, supplying the electric power supplied from the second battery to the elements through the second terminal after the first battery connected to the first terminal is detached from the mounting portion, supplying the electric power supplied from the second battery through the first terminal and the second terminal to the elements after the first power output terminal of the second battery is connected to the first terminal from which the first battery was detached, and supplying the electric power from the second battery through the first terminal to the elements after the cable connected to the second battery is detached from the second terminal.

Accordingly, since while electric power is supplied to the first terminal from the first battery to be replaced, electric power is also supplied to the second terminal from the second battery which is fully charged, a video camera is capable of performing a shooting operation in a place where a commercial power supply is not available.

### BRIEF DESCRIPTION OF THE DRAWINGS

FIG. 1 is a schematic view illustrating a video camera according to a first embodiment of the present invention;

FIG. 2 is a diagram illustrating an example of a power supply circuit included in the video camera according to the first embodiment;

FIG. 3 is a schematic view illustrating a cable terminal;

FIG. 4 is a front view illustrating a housing of a body to which the cable terminal is connected;

FIG. 5 is a partial sectional view illustrating the housing in a state in which the cable terminal is being connected thereto;

FIGS. 6A to 6C are schematic views illustrating a method for detecting insertion of a terminal portion;

FIG. 7 is a schematic diagram illustrating examples of operation steps of the video camera according to the first embodiment;

FIG. 8 is a diagram illustrating an example of a power supply circuit included in a video camera according to a second embodiment of the present invention;

FIG. 9 is a schematic diagram illustrating examples of operation steps of the video camera according to the second embodiment; and

FIG. 10 is a schematic diagram illustrating examples of display of the video camera according to the second embodiment.

### DESCRIPTION OF THE PREFERRED EMBODIMENTS

Embodiments of the present invention will be described in detail hereinafter with reference to the accompanying drawings.

### First Embodiment

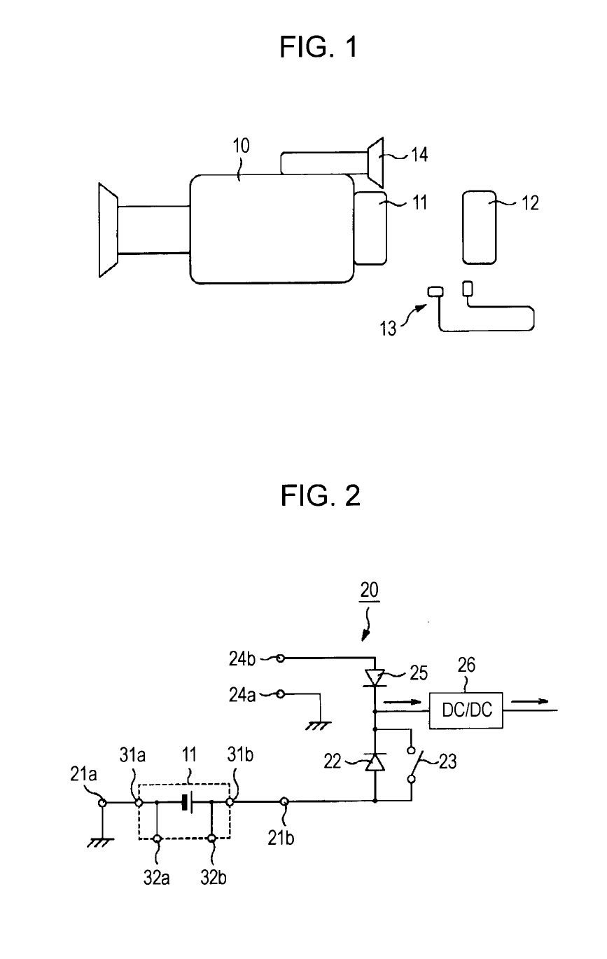

FIG. 1 is a schematic view illustrating a video camera according to a first embodiment of the present invention. A video camera 10 includes components such as a display unit, a recording unit, a lens driving unit, and an electronic circuit. A battery 11 which supplies electric power to the components in a body of the video camera 10 is detachably attached to a mounting portion of the video camera 10. Accordingly, the video camera 10 performs a shooting operation even in places where a commercial power supply is not available such as in the wilderness. Furthermore, the battery 11 of the video camera 10 is replaced with a spare battery 12 without shutting off power.

Specifically, the video camera 10 includes first power supply terminals to which electric power is supplied and which are disposed in the mounting portion of the video camera 10 to which the battery 11 is attached, and second power supply terminals which are electrically connected to the battery 11 through a cable 13 and which are arranged in positions which does not disturb replacement of the battery 11 connected to the first power supply terminals. Each of the battery 11 and the spare battery 12 has first and second battery terminals which output electric power. Accordingly, for example, when the battery 11 is connected to the first power supply terminals, the video camera 10 receives electric power from the spare battery 12 by connecting the spare battery 12 to the second power supply terminals using the flexible cable 13. Consequently, the power supply is not interrupted when the battery 11 is detached. Then, one of the first and second battery terminals of the spare battery 12, the terminals not being connected to the cable 13, are connected to the first power supply terminals after the battery 11 is detached, and the cable 13 is detached from the spare battery 12. In this way, the battery 11 is replaced by the spare battery 12. Since the battery 11 is replaced by the spare battery 12 step-by-step as described above, the video camera 10 continuously performs a shooting operation in the field without the need for a commercial power supply.

The video camera 10 includes a viewfinder 14, and the user may carry the video camera 10 on a user's shoulder for a shooting operation, for example.

FIG. 2 is a diagram illustrating an example of a power supply circuit of the video camera 10. The power supply circuit 20 includes first power supply terminals 21a and 21b, a first rectifying device 22, a switch 23, second power supply terminals 24a and 24b, a second rectifying device 25, and a DC/DC converter 26.

The battery 11 includes first battery terminals 31a and 31b to be connected to the first power supply terminals 21a and 21b and second battery terminals 32a and 32b to be connected to terminals of the cable 13. Note that the spare battery 12 (not shown) similarly includes first battery terminals to be connected to the first power supply terminals 21a and 21b and second battery terminals to be connected to the terminals of the cable 13.

The first power supply terminals 21a and 21b are disposed in the mounting portion to which the battery 11 or the spare battery 12 is detachably attached. When the battery 11 or the spare battery 12 is attached to the mounting portion, the first power supply terminals 21a and 21b are connected to the first battery terminals of the battery 11 or the spare battery 12, and power is supplied from the battery 11 or the spare battery 12. The power input from the first power supply terminals 21a and 21b is supplied to the first rectifying device 22 and the switch 23.

The first rectifying device 22 is a diode which allows a current to flow in one direction, for example. The first rectifying device 22 allows a current to flow from the first power supply terminal 21b to the DC/DC converter 26 and prevents a current from flowing in the opposite direction. By this, the first rectifying device 22 prevents the battery 11 or the spare battery 12 from being heated due to a current being reversely supplied.

The switch 23 is used to make a voltage drop of the first rectifying device 22 minimum. When the switch 23 is turned on, the current supplied to the first rectifying device 22 is negligible, whereas when the switch 23 is turned off, the current is supplied to the first rectifying device 22. The switch 23 is turned on or off in accordance with whether electric power is supplied from the second power supply terminals 24a and 24b. Specifically, when the electric power is supplied from the second power supply terminals 24a and 24b, the switch 23 is turned off, whereas when the electric power is not supplied from the second power supply terminals 24a and 24b, the switch 23 is turned on. In this way, the switch 23 prevents the current supplied from the second power supply terminals 24a and 24b from being supplied to the first power supply terminals 21a and 21b.

The second power supply terminals 24a and 24b are arranged so as to be connected to the cable 13 even when the battery 11 or the spare battery 12 is attached to the mounting portion. Accordingly, when the battery 11 or the spare battery 12 is attached to the mounting portion, electric power is supplied to the first power supply terminals 21a and 21b, and in addition, electric power is supplied from the battery 11 or the spare battery 12 to the second power supply terminals 24a and 24b through the cable 13.

The second rectifying device 25 is a diode which allows a current to flow in one direction, for example. The second rectifying device 25 allows a current to flow from the second power supply terminal 24b to the DC/DC converter 26 and prevents a current from flowing in the opposite direction. By this, the second rectifying device 25 prevents the battery 11 or the spare battery 12 from being heated due to a current reversely being supplied.

The DC/DC converter 26 causes the voltage of the electric power supplied from the first power supply terminals 21a and 21b or the second power supply terminals 24a and 24b to increase or decrease and outputs the voltage to the components of the video camera 10. The components include the display unit, the recording unit, the lens driving unit, and the electronic circuit.

An on/off operation of the switch 23 described above will be described in detail hereinafter. As an example, the switch 23 is switched in accordance with a result of the determination as to whether the terminals of the cable 13 are connected to the second power supply terminals 24a and 24b. That is, in this example, electric power to be supplied to the first rectifying device 22 is controlled in accordance with the result of the determination as to whether the terminals of the cable 13 are connected to the second power supply terminals 24a and 24b.

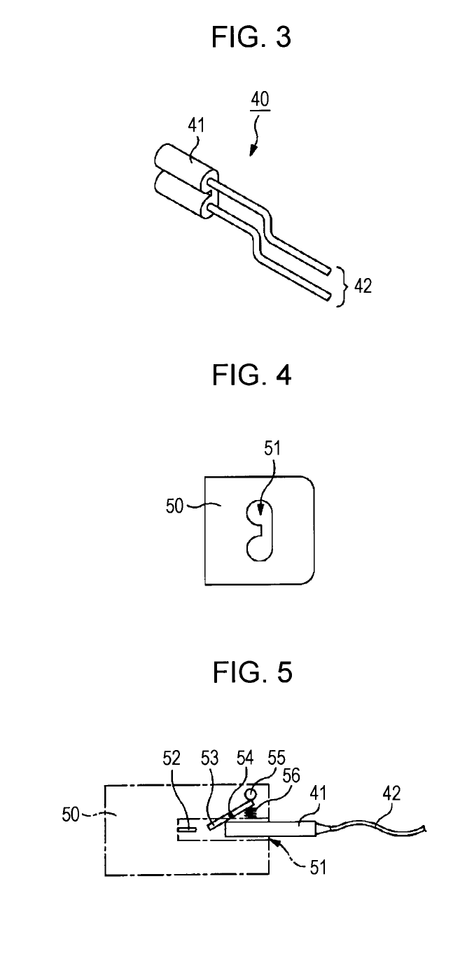

FIG. 3 shows a schematic view illustrating a cable terminal. Each of cable terminals 40a and 40b (hereinafter referred to as cable terminals 40 unless otherwise distinguished) includes a terminal portion 41 and a flexible cable portion 42. The terminal portion 41 is formed of an insulating member having a predetermined shape and is provided with recessed terminals in predetermined positions thereof which are electrically connected to cable cores included in the cable portion 42.

FIG. 4 is a front view illustrating a housing of the body to which one of the cable terminals 40a and 40b is connected. FIG. 5 is a partial sectional view of the housing in a state in which one of the cable terminals is connected thereto. A housing 50 includes an insertion portion 51 in which the terminal portion 41 of the cable 13 is detachably fitted, projecting terminals 52 which are electrically connected to the recessed terminals of the terminal portion 41, a switch member 53 which detects an insertion of the terminal portion 41, a switch supporting point 54 which is a point supporting the switch member 53, a switch contact 55 which is used to turn on or off a circuit of the switch 23 in accordance with turning of the switch member 53, and a spring 56 which urges the switch member 53 against the switch contact 55.

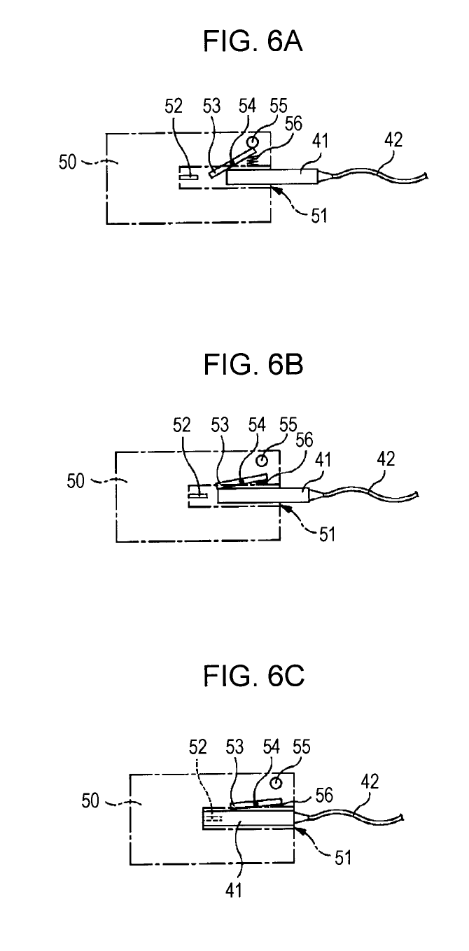

As shown in FIG. 6A, when the terminal portion 41 is inserted into the insertion portion 51 and the terminal portion 41 of the cable 13 has not yet pushed the switch member 53 upward, the switch member 53 is connected to the switch contact 55. Therefore, the switch 23 is turned on, and the current supplied to the first rectifying device 22 is negligible.

When the terminal portion 41 is deeply inserted into the insertion portion 51 as shown in FIG. 6B, the switch member 53 is pushed up using the terminal portion 41, is turned about the switch supporting point 54 as a supporting point, and is separated from the switch contact 55. Accordingly, the switch 23 is turned off and the current is supplied to the first rectifying device 22.

The terminal portion 41 is further deeply inserted into the insertion portion 51 as shown in FIG. 6C, the projecting terminals 52 of the insertion portion 51 is electrically connected to the recessed terminals of the terminal portion 41. Accordingly, electric power is supplied to the second power supply terminals 24a and 24b, that is, the electric power is supplied to the components of the video camera 10.

As described above, when it is determined that one of the cable terminals 40 is inserted into the insertion portion 51, the switch is turned off, and electric power supplied to the first power supply terminals 21a and 21b is rectified using the first rectifying device 22 and is further supplied to the DC/DC converter 26. Accordingly, a current supplied through the cable 13 is prevented from being supplied to the first power supply terminal 21b. On the other hand, when it is determined that any of the cable terminals 40 is not inserted into the insertion portion 51, the switch 23 is turned on, and electric power supplied to the first power supply terminal 21a and 21b is not rectified using the first rectifying device 22 and is further supplied to the DC/DC converter 26. Accordingly, the voltage drop of the first rectifying device 22 is minimized. Note that the second rectifying device 25 also has a switch similarly to the first rectifying device 22 so that a current supplied to the second rectifying device 25 is controlled.

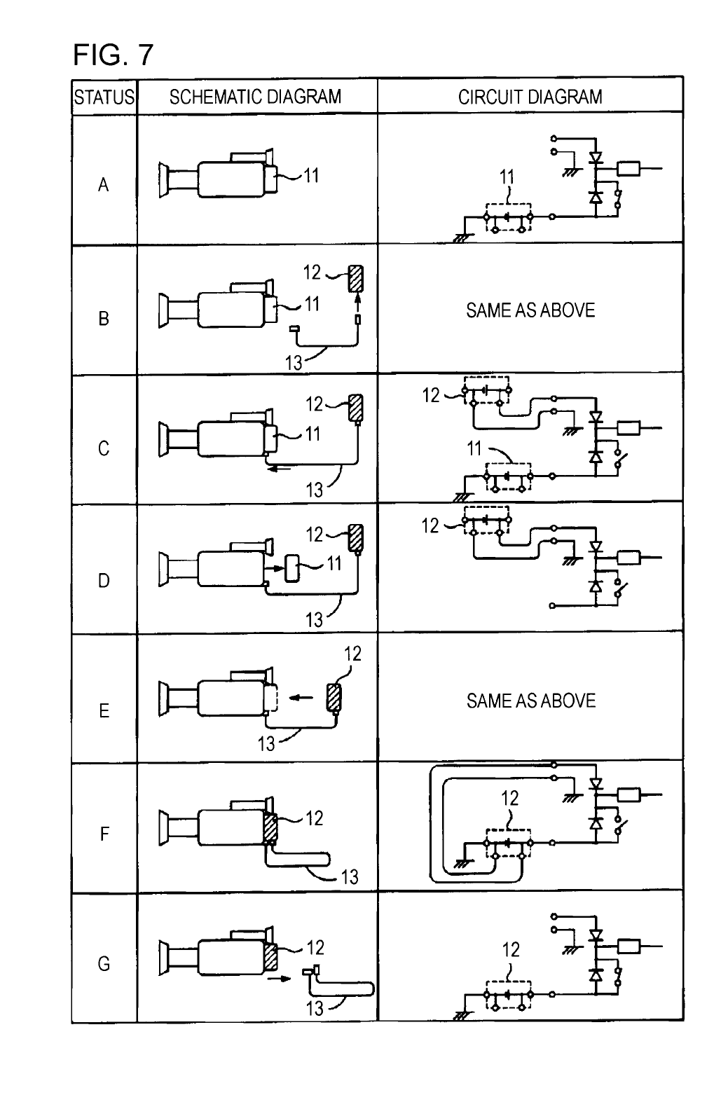

Referring to FIG. 7, operation of the video camera 10 when a battery is changed to a new one will be described. In this embodiment, the battery 11 which has been used is changed to the spare battery 12 which is fully charged.

As shown in (A) of FIG. 7, the video camera 10 receives electric power from the battery 11. Specifically, a current discharged from the battery 11 is supplied through the first power supply terminal 21b to the switch 23 and the DC/DC converter 26. In this state, since the switch 23 is in an on state, the current supplied to the first rectifying device 22 is negligible. Therefore, the voltage drop of the first rectifying device 22 is minimized and power consumption of the battery 11 is suppressed. Accordingly, the video camera 10 is capable of performing the shooting operation for a long period of time even in a place such as in the field where AC (alternating current) electric power, which is a commercial power supply, is not available.

When changing the battery 11 to the spare battery 12 which is fully charged, a user connects the cable 13 to the spare battery 12 as shown in (B) of FIG. 7. In this state, the spare battery 12 is connected to the cable 13 through the first cable terminal 40a and the second battery terminals.

Then, the user inserts the second cable terminal 40b into the insertion portion 51 of the video camera 10. Since the second cable terminal 40b is detected as described above, the switch 23 is turned off. Then, the video camera 10 receives power supplies from the battery 11 and the spare battery 12. Specifically, as shown in (C) of FIG. 7, the current discharged from the battery 11 is supplied from the first power supply terminal 21b to the first rectifying device 22 and the DC/DC converter 26 whereas a current discharged from the spare battery 12 is supplied from the second power supply terminals 24b to the second rectifying device 25 and the DC/DC converter 26.

Thereafter, the user removes the battery 11 in which a battery level thereof is low from the mounting portion of the video camera 10. After the battery 11 is detached from the video camera 10, the video camera 10 only receives the power supply from the spare battery 12. Specifically, as shown in (D) of FIG. 7, the current discharged from the spare battery 12 is supplied from the second power supply terminal 24b to the second rectifying device 25 and the DC/DC converter 26.

After the battery 11 is detached from the first power supply terminals 21a and 21b, the user connects the spare battery 12 to the first power supply terminals 21a and 21b as shown in (E) and (F) of FIG. 7. The video camera 10 receives the power supply from the spare battery 12 through the first power supply terminals 21a and 21b and the second power supply terminals 24a and 24b. Specifically, as shown in (F) of FIG. 7, the current discharged from the spare battery 12 is supplied from the second power supply terminal 24b to the second rectifying device 25 and the DC/DC converter 26, and is also supplied from the first power supply terminal 21b to the first rectifying device 22 and the DC/DC converter 26.

Thereafter, the user disconnects the cable 13 from the second power supply terminals 24a and 24b and the second battery terminals. Since it is determined that any of the cable terminals is not detected, the switch 23 is turned on. Accordingly, the video camera 10 only receives the power supply from the spare battery 12. Specifically, as shown in (G) of FIG. 7, the current discharged from the spare battery 12 is supplied from the first power supply terminal 21b to the switch 23 and the DC/DC converter 26. This state is similar to the state shown in (A) of FIG. 7.

Since the batteries are exchanged as described above, the video camera 10 is capable of performing the shooting operation for a long period of time even in a place where a commercial power supply is not available. Furthermore, since an additional inner battery and an adapter for a commercial power supply, for example, are not necessary, burden of the user of the video camera 10 is reduced when the shooting operation is performed for a long period of time.

### Second Embodiment

A video camera according to a second embodiment detects an amount of battery power and informs a user of the amount of the battery power and a timing of replacement of a battery. Note that reference numerals the same as those used for the video camera 10 according to the first embodiment are used to denote similar components, and descriptions thereof are omitted.

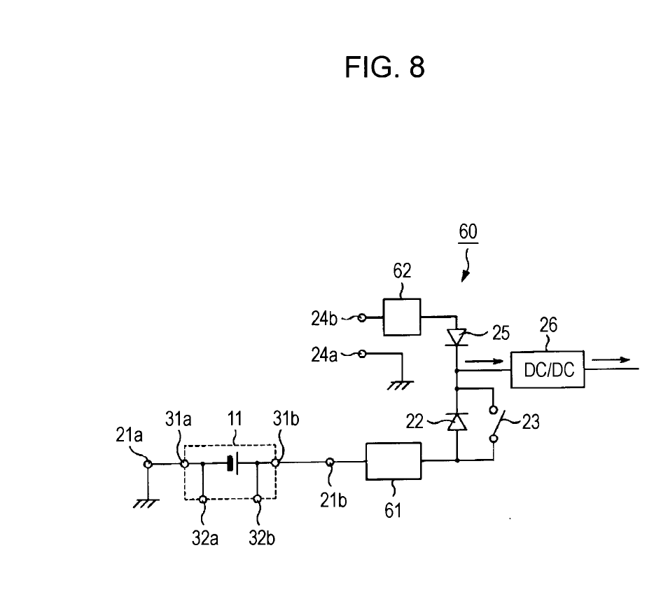

FIG. 8 is a diagram illustrating an example of a power supply circuit of the video camera according to the second embodiment. A power supply circuit 60 includes first power supply terminals 21a and 21b, a first detection circuit 61, a first rectifying device 22, a switch 23, second power supply terminals 24a and 24b, a second detection circuit 62, a second rectifying device 25, and a DC/DC converter 26. Specifically, the power supply circuit 60 is configured such that, in the configuration of the power supply circuit shown in FIG. 2, the first detection circuit 61 is arranged between the first power supply terminals 21a and 21b and the first rectifying device 22, and the second detection circuit 62 is arranged between the second power supply terminals 24a and 24b and the second rectifying device 25 so that an amount of the battery power is detected using each of the first detection circuit 61 and the second detection circuit 62.

The first detection circuit 61 is used to measure a current supplied from the first power supply terminal 21b, a voltage, and a temperature and detect the amount of battery power. The second detection circuit 62 is used to measure a current supplied from the second power supply terminal 24b, a voltage, and a temperature and detect the amount of battery power. Examples of a method for detecting an amount of battery power include a method for detecting an amount of battery power in accordance with a voltage of a battery and a method for detecting an amount of battery power by integrating a discharging amount of a battery.

The video camera includes a display unit such as a viewfinder, a liquid crystal panel, or an LED (light emitting diode), and informs the user of remaining battery power and a timing of replacement of the battery using the display unit. In particular, when a shooting operation is performed for a long period of time, a viewfinder is preferably used for the notification.

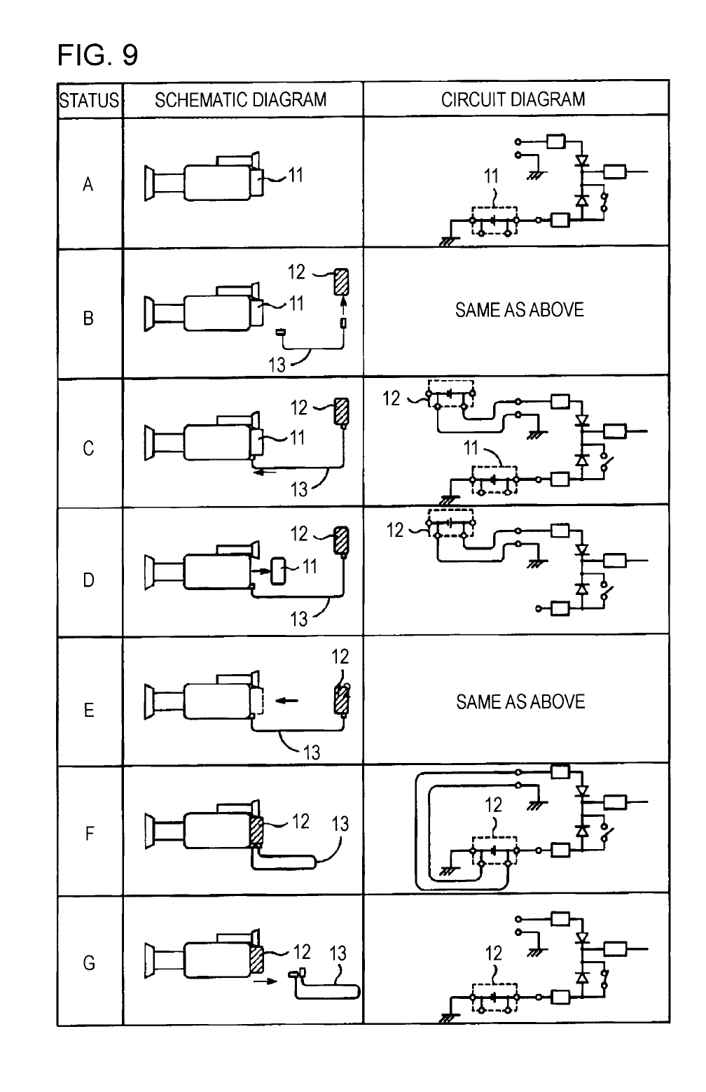

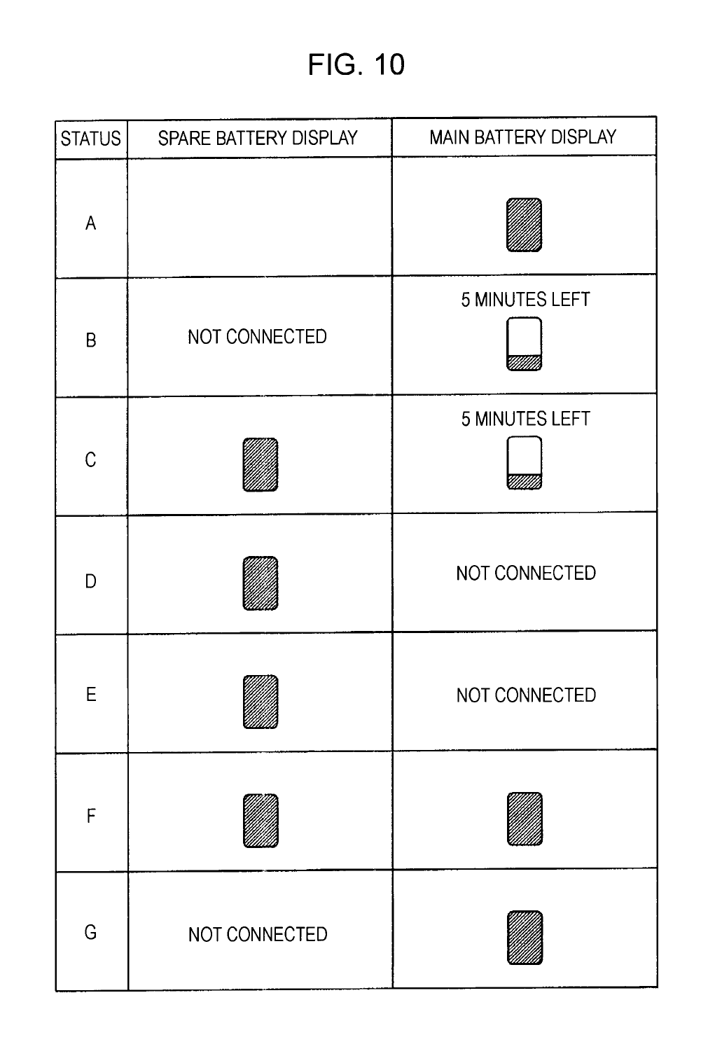

Referring to FIGS. 9 and 10, operation of a video camera 10 according to the second embodiment and a display example of the display unit when the battery is changed to a new one will be described. In this example, an amount of power of a battery connected to the first power supply terminals 21a and 21b and an amount of power of a battery connected to the second power supply terminals 24a and 24b are displayed in a main battery display unit and a spare battery display unit, respectively, arranged in the display unit such as the viewfinder.

The video camera 10 shown in (A) of FIG. 9 receives electric power supplied from a battery 11. Specifically, a current discharged from the battery 11 is supplied from the first power supply terminal 21b to the first detection circuit 61, the switch 23, and the DC/DC converter 26. The first detection circuit 61 detects an amount of remaining power of the battery 11, and the amount of the remaining power of the battery 11 is displayed in the main battery display unit as shown in (A) of FIG. 10, for example.

When it is determined that a level of the battery 11 is low, a notification “5 minutes left”, for example, is displayed in the main battery display unit of the video camera 10 as shown in (B) of FIG. 10. In addition, a notification “not connected”, for example, is displayed in the spare battery display unit of the video camera 10 so as to prompt the user to replace the battery.

When the battery 11 is to be replaced, the user connects a spare battery 12, which is fully charged, to a cable 13. The spare battery 12 is connected to the cable 13 through a first cable terminal 40a and second battery terminals.

Then, the user inserts a second cable terminal 40b into an insertion portion 51 of the video camera 10. Since the second cable terminal 40b is detected as described above, the switch 23 is turned off. Then, the video camera 10 receives power supplied from the battery 11 and the spare battery 12. Specifically, as shown in (C) of FIG. 9, the current discharged from the battery 11 is supplied from the first power supply terminal 21b to the first detection circuit 61, the first rectifying device 22, and the DC/DC converter 26 whereas a current discharged from the spare battery 12 is supplied from the second power supply terminals 24b to the second detection circuit 62, the second rectifying device 25, and the DC/DC converter 26. The first detection circuit 61 detects an amount of remaining power of the battery 11, and the second detection circuit 62 detects an amount of remaining power of the spare battery 12. The detected amount of the remaining power of the battery 11 and the detected amount of the remaining power of the spare battery 12 are displayed in the main battery display unit and the spare battery display unit, respectively, as shown in (C) of FIG. 10, for example.

Accordingly, the user confirms that the spare battery 12 is fully charged and the battery to be removed. Furthermore, since the user confirms that the video camera 10 receives power supply from the battery 11 and the spare battery 12, the user removes the battery 11 without anxiety.

Next, the user removes the battery 11 in which a battery level thereof is low from a mounting portion of the video camera 10. After the battery 11 is detached from the video camera 10, the video camera 10 only receives the power supply from the spare battery 12. Specifically, as shown in (D) of FIG. 9, the current discharged from the spare battery 12 is supplied from the second power supply terminal 24b to the second detection circuit 62, the second rectifying device 25, and the DC/DC converter 26. The amount of remaining power of the spare battery 12 is displayed in the spare battery display unit of the video camera 10 and a notification “not connected” is displayed in the main battery display unit as shown in (D) of FIG. 10.

After the battery 11 is detached from the first power supply terminals 21a and 21b, the user connects the spare battery 12 to the first power supply terminals 21a and 21b as shown in (E) and (F) of FIG. 9. The video camera 10 receives the power supply from the spare battery 12 through the first power supply terminals 21a and 21b in addition to the second power supply terminals 24a and 24b. Specifically, as shown in (F) of FIG. 9, the current discharged from the spare battery 12 is supplied from the second power supply terminal 24b to the second detection circuit 62, the second rectifying device 25, and the DC/DC converter 26, and is also supplied from the first power supply terminal 21b to the first detection circuit 61, the first rectifying device 22, and the DC/DC converter 26. The amount of remaining power of the spare battery 12 is displayed in the main battery display unit and the spare battery display unit of the video camera 10 as shown in (F) of FIG. 10. Note that a notification “detach the cable” may be displayed in the spare battery display unit so as to prompt the user to remove the cable 13.

Thereafter, the user detaches the cable 13 from the second power supply terminals 24a and 24b and the second battery terminals. Since it is determined that the cable terminal is not detected, the switch 23 is turned on. Accordingly, the video camera 10 only receives the power supply from the spare battery 12. Specifically, as shown in (G) of FIG. 9, the current discharged from the spare battery 12 is supplied from the first power supply terminal 21b to the first detection circuit 61, the switch 23, and the DC/DC converter 26. This state is similar to the state shown in (A) of FIG. 9. The amount of the remaining power of the spare battery 12 is displayed in the main battery display unit of the video camera 10 as shown in (G) of FIG. 10, for example.

Since the amounts of remaining power of the batteries are displayed in the main battery display unit and the spare battery display unit, the user replaces the battery 11 while confirming the connection of the spare battery 12. Accordingly, the battery 11 is securely changed to the spare battery 12 without interruption of the power supply.

Note that the present invention is not limited to the embodiments described above, and various modification may be made without departing from the scope of the invention. For example, in the forgoing embodiments, a video camera is taken as an example of an electronic apparatus. However, the present invention is not limited to this. The present invention is suitably applied to portable recording apparatuses used to record video images and audio for a long period of time. However, the present invention may be employed in portable editing apparatuses. In this case, an excellent editing operation is attained in a location where the shooting operation is performed.

What is claimed is:

1. An electronic apparatus comprising:
a first terminal which is disposed on a mounting portion in which a first battery or a second battery is to be mounted, and which is to be electrically connected to one of the first and second batteries;
a second terminal which is to be electrically connected to the second battery through a cable and which is located in a position which does not disturb replacement of the first battery connected to the first terminal;
elements which consume electric power; and
supply means configured to supply at least one of electric power supplied from the first terminal and electric power supplied from the second terminal to the elements,
wherein the supply means supplies the electric power supplied from the first terminal and the electric power supplied from the second terminal to the elements when the first terminal is connected to the first battery and the second terminal is connected to the second battery through a cable,
the electric power input to the second terminal is supplied to the elements after the first battery is detached from the mounting portion and the second terminal is connected to the second battery through the cable,
the electric power input to the first terminal and the electric power input to the second terminal are supplied to the elements after the first terminal is connected to the second battery and the second terminal is connected to the second battery through the cable, and
the electric power input to the first terminal is supplied to the elements after the cable connected to the second battery is detached from the second terminal.

2. The electronic apparatus according to claim 1, comprising:
detecting means configured to detect at least one of pairs of connection between the first and second terminals and the first and second batteries; and
a rectifying element configured to rectify at least one of the electric power input to the first terminal and the electric power input to the second terminal,
wherein the supply means controls supply of electric power to the rectifying element in accordance with a result of a detection obtained using the detecting means.

3. The electronic apparatus according to claim 2, further comprising:
notifying means configured to notify a user of the result of the detection obtained using the detecting means.

4. The electronic apparatus according to claim 3, further comprising:
sensing means configured to detect an amount of remaining power of the first battery and an amount of remaining power of the second battery connected to the first and second terminals,
wherein the notifying means notifies a user of a result of a detection obtained using the sensing means.

5. A power supply system comprising:
a first battery having a first power output terminal and a second power output terminal and a second battery having a first power output terminal and a second power output terminal;
a first terminal which is disposed on a mounting portion in which a first battery or a second battery is to be mounted, and which is to be electrically connected to one of the first power output terminal of the first battery and the first power output terminal of the second battery;
a second terminal which is to be electrically connected to the second power output terminal of the second battery through a cable and which is located in a position which does not disturb replacement of the first battery connected to the first terminal;
elements which consume electric power; and
supply means configured to supply at least one of electric power supplied from the first terminal and electric power supplied from the second terminal to the elements,
wherein the electric power input to the first terminal and the electric power input to the second terminal are supplied to the elements after the first terminal is connected to the first power output terminal of the first battery and the second terminal is connected to the second power output terminal of the second battery through the cable,
the electric power input to the second terminal is supplied to the elements after the first battery is detached from the mounting portion and the second terminal is connected to the second power output terminal of the second battery through the cable, and
the electric power input to the first terminal and the electric power input to the second terminal are supplied to the elements after the first terminal is connected to the first power output terminal of the second battery and the second terminal is connected to the second power output terminal of the second battery through the cable.

6. A method for supplying electric power to a power supply system including a first battery having a first power output terminal and a second power output terminal and a second battery having a first battery having a first power output terminal and a second power output terminal and a second battery having a first power output terminal and a second power output terminal, a first terminal which is disposed on a mounting portion in which a first battery or a second battery is to be mounted, and which is to be electrically connected to one of the first power output terminal of the first battery and the first power output terminal of the second battery, a second terminal which is to be electrically connected to the second power output terminal of the second battery through a cable and which is located in a position which does not disturb replacement of the first battery connected to the first terminal, elements which consume electric power, and supply means configured to supply at least one of electric power supplied from the first terminal and electric power supplied from the second terminal to the elements, the method comprising the steps of:
supplying the electric power supplied from the first battery and the electric power supplied from the second battery to the first terminal and the second terminal, respectively, to the elements, the first terminal being connected to the first power output terminal of the first battery, the second terminal being connected to the second power output terminal of the second battery through the cable;
supplying the electric power supplied from the second battery to the elements through the second terminal after the first battery connected to the first terminal is detached from the mounting portion;
supplying the electric power supplied from the second battery through the first terminal and the second terminal to the elements after the first power output terminal of the second battery is connected to the first terminal from which the first battery was detached; and
supplying the electric power from the second battery through the first terminal to the elements after the cable connected to the second battery is detached from the second terminal.

7. An electronic apparatus comprising:
a first terminal which is disposed on a mounting portion in which a first battery or a second battery is to be mounted, and which is to be electrically connected to one of the first and second batteries;
a second terminal which is to be electrically connected to the second battery through a cable and which is located in a position which does not disturb replacement of the first battery connected to the first terminal;
elements which consume electric power; and
a supply unit configured to supply at least one of electric power supplied from the first terminal and electric power supplied from the second terminal to the elements,
wherein the supply unit supplies the electric power supplied from the first terminal and the electric power supplied from the second terminal to the elements when the first terminal is connected to the first battery and the second terminal is connected to the second battery through a cable,
the electric power input to the second terminal is supplied to the elements after the first battery is detached from the mounting portion and the second terminal is connected to the second battery through the cable,
the electric power input to the first terminal and the electric power input to the second terminal are supplied to the elements after the first terminal is connected to the second battery and the second terminal is connected to the second battery through the cable, and
the electric power input to the first terminal is supplied to the elements after the cable connected to the second battery from the second terminal.
